(19) United States
(12) Patent Application Publication
(10) Pub. No.: US 2013/0343164 A1
(43) Pub. Date: Dec. 26, 2013

(54) Daily Timer

(71) Applicant: James Hahn Novak, Orlando, FL (US)

(72) Inventor: James Hahn Novak, Orlando, FL (US)

(21) Appl. No.: 13/923,351

(22) Filed: Jun. 20, 2013

Related U.S. Application Data
(60) Provisional application No. 61/662,429, filed on Jun. 21, 2012.

(51) Int. Cl. G04G 9/00

(52) U.S. Cl. CPC G04G 9/00
USPC 368/29

(57) ABSTRACT

A timer counts days, instead of minutes, typically up to 365 days. A “day” button can be pressed to select the number of days before an alarm sounds.

When the start/stop button is pressed, after setting the number of days, the alarm will sound at the same time of the day, the set number of days in the future, that the start/stop button was pressed. The timer automatically repeats the last programmed daily amount to protect the user from forgetting to re-program for another countdown. If the user wants to program a different number of days, they can press a reset button and enter the number of days for the next event. The timer can be mounted in various manners and its housing can be designed for providing such various mounting options.

### CROSS-REFERENCE TO RELATED APPLICATION

This application claims the benefit of priority of U.S. provisional application No. 61/662,429, filed Jun. 21, 2012, the contents of which are herein incorporated by reference.

### BACKGROUND OF THE INVENTION

The present invention relates to timers and, more particularly, to a digital timer that counts days instead of minutes, up to 365 days.

Many times, people require reminders every set number of days. For example, property managers and tenants often forget to change their air conditioning/furnace filters and many people are noncompliant with medication administration.

Current reminder systems include phone applications or computer programs. These systems, however, require the related device, such as a phone or computer, to operate. Many people don't have access to these devices or may be overwhelmed by the operation and programming of these devices. Many people have phone application overload and may neglect to use applications on their phone or computer.

Email reminders may be used as well. However this also requires the use of a computing device to receive the messages and/or reminders. Moreover, with large volumes of email messages received daily, such messages and/or reminders may be missed or simply ignored.

As can be seen, there is a need for an easy to use, stand-alone timer that can count periods in days instead of hours or minutes.

### SUMMARY OF THE INVENTION

In one aspect of the present invention, a timer comprises a display; a day button for adjusting a number of days before an alert is sounded; and a start/stop button for starting a countdown to the number of days set by pressing the day button, wherein the timer is programmed to countdown in only days, without an adjustment for setting hours or minutes.

In another aspect of the present invention, a method for counting down a desired number of days on a timer comprises depressing a day button to adjust the desired number of days before an alert is sounded, the number of days being shown on a display of the timer; and starting a countdown to the desired number of days set by depressing a start/stop button, wherein the timer is programmed to countdown in only days, without an adjustment for setting hours or minutes.

These and other features, aspects and advantages of the present invention will become better understood with reference to the following drawings, description and claims.

### BRIEF DESCRIPTION OF THE DRAWINGS

FIG. 1 is a front perspective view of a timer according to an exemplary embodiment of the present invention;

FIG. 2 is a back perspective view of the timer of FIG. 1;

FIG. 3 is an exploded perspective view of the timer of FIG. 1; and

FIG. 4 is a cross-sectional view taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a timer that counts days, instead of minutes, typically up to 365 days. A “day” button can be pressed to select the number of days before an alarm sounds. When the start/stop button is pressed, after setting the number of days, the alarm will sound at the same time of the day, the set number of days in the future, that the start/stop button was pressed. The timer automatically repeats the last programmed daily amount to protect the user from forgetting to re-program for another countdown. If the user wants to program a different number of days, they can press a reset button and enter the number of days for the next event. The timer can be mounted in various manners and its housing can be designed for providing such various mounting options, including a magnet, flip out stand, sticky pad or hole for nail or screw mounting.

The timer is designed to be small and portable, allowing the timer to be placed in a location related to the task to be remembered. For example, the timer can be placed in a location near medication to remind the user to take medication, or may be attached to a furnace/AC housing to remind the user to change their furnace filter.

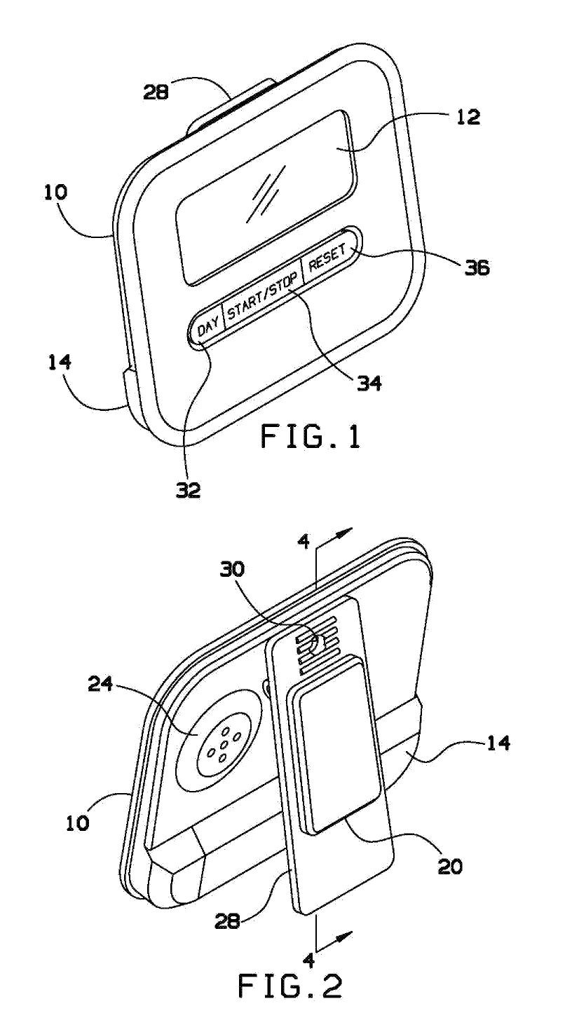

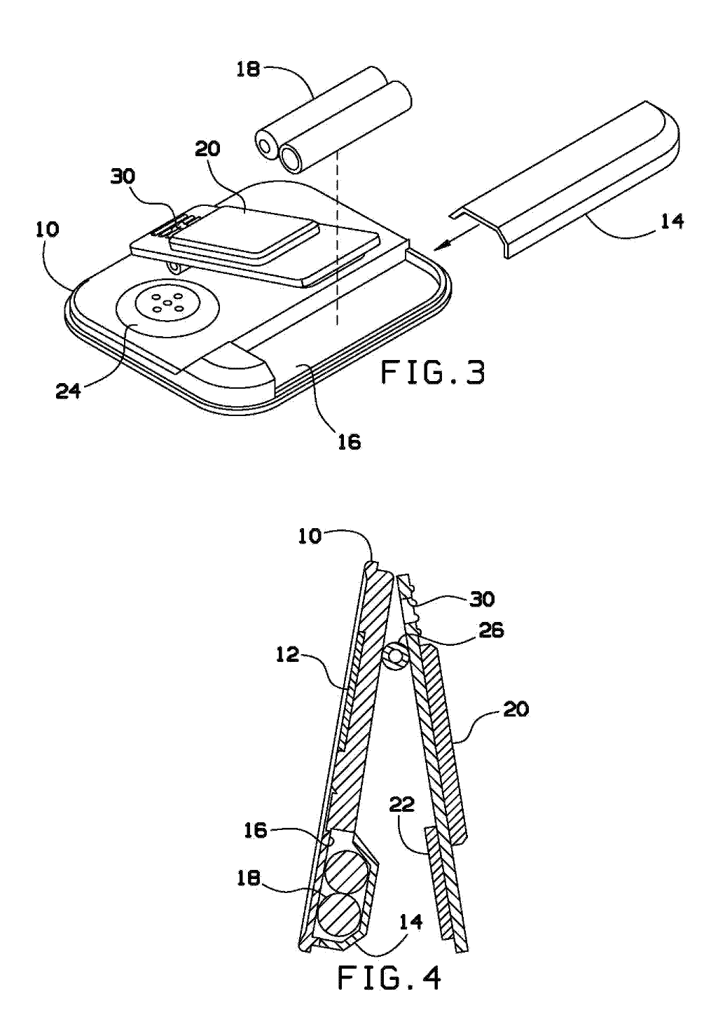

Referring now to FIGS. 1 through 4, a timer can be contained within a timer housing 10 and a display 12, such as a liquid crystal display (LCD) can be viewed from a front face of the housing 10. Control buttons, such as a day button 32, a start/stop button 34 and a reset button 36 can be accessed from the front face of the housing 10.

A speaker 24 can be designed to provide an alert. The alert can take various forms, such as a continuous beep, a periodic chirp, a siren-like alarm, or the like. The alert can sound at various times. For example, the alert can sound for a certain period of time continuously and, if not acknowledged and reset, the alert can sound periodically until reset. In some embodiments, when the alert sounds, the display 12 can show the time since the alert sounded.

The display can take various forms and can include various information. In some embodiments, the display can include a number of days, from 1 to 365, remaining until the alert. The display can include the icon “countdown” which can flash while the timer is counting down. In some embodiments, the display can include a battery icon. This icon can flash to indicate a low battery. For example, this icon can flash when the charge falls below 2.6V to signal a low battery. When the timer completes a countdown, it will sound an alarm and also, in some embodiments, an alarm icon on the display can flash.

Various methods can be included with the timer for mounting or displaying the timer. For example, a folding stand 28 can fold out about a hinge 26 to support the timer on a horizontal surface. A magnet 20 and a sticky pad 22 can be disposed behind the timer for attaching the timer to a surface, such as a furnace, a wall, a cabinet, or the like. Finally, a hail hole 30 can be provided to allow the timer to mount to a surface with a nail or screw.

The back face of the timer can include a battery compartment cover 14 that can cover a battery compartment 16 to house one or more batteries 18. Other power supplies may also be used to power the timer, such as an AC/DC transformer/plug-in power, solar power, or the like.

To use the timer of the present invention, a user can first decide what task they wish to use the timer and how many days to program. For example, if a medication needs to be taken every 30 days, the user can press the day button 32 to show “30” on the display 12. Functionality can be provided to allow a user to hold down the day button 32 to quickly advance the number of days. At the time of day that the user wishes to be reminded, they would then press the start/stop button 34. At this point, the timer will count down the number of days and sound an alert at the same time of day the start/stop button 34 was pressed, but 30 days later. When the alert sounds, the user can press the start/stop button 34 to acknowledge the alert and restart another 30 day countdown. In some embodiments, the new 30 day countdown will be exactly 30 days from the time the alarm sounded. In other embodiments, the new 30 day countdown will be 30 days from the time the alert was restarted by pressing the start/stop button. Either way, the alarm can automatically reset unless the reset button 36 is pressed. If the reset button 36 is pressed, the user can select a different number of days for the alert to be activated.

A software implementation of the present invention can include the functionality of the physical device. The software digital timer may allow a user to set multiple events, such as more than 10 events, for the timer.

It should be understood, of course, that the foregoing relates to exemplary embodiments of the invention and that modifications may be made without departing from the spirit and scope of the invention as set forth in the following claims.

What is claimed is:

1. A timer comprising:
a display;
a day button for adjusting a number of days before an alert is sounded; and
a start/stop button for starting a countdown to the number of days set by pressing the day button, wherein
the timer is programmed to countdown in only days, without an adjustment for setting hours or minutes.

2. The timer of claim 1, further comprising a reset button for resetting the number of days.

3. The timer of claim 1, further comprising means for supporting the timer.

4. The timer of claim 1, wherein the means for supporting the timer includes a folding stand.

5. The timer of claim 1, wherein the means for supporting the timer includes a magnet.

6. The timer of claim 1, wherein the means for supporting the timer includes a sticky pad.

7. The timer of claim 1, wherein the means for supporting the timer includes a nail hole.

8. A method for counting down a desired number of days on a timer, comprising:
depressing a day button to adjust the desired number of days before an alert is sounded, the number of days being shown on a display of the timer; and
starting a countdown to the desired number of days set by depressing a start/stop button, wherein
the timer is programmed to countdown in only days, without an adjustment for setting hours or minutes.

9. The method of claim 8, further comprising resetting the desired number of days by depressing a reset button.

10. The method of claim 8, further comprising supporting the timer by at least one of a folding stand, a wall mount nail hole, a magnet and a sticky pad.
